(19) United States
(12) Patent Application Publication
(10) Pub. No.: US 2014/0047378 A1
(43) Pub. Date: Feb. 13, 2014

(54) IMAGE PROCESSING DEVICE, IMAGE DISPLAY APPARATUS, IMAGE PROCESSING METHOD, AND COMPUTER PROGRAM MEDIUM

(71) Applicant: KABUSHIKI KAISHA TOSHIBA, Tokyo (JP)

(72) Inventors: Daisuke HIRAKAWA, Saitama (JP); Yoshiyuki KOKOJIMA, Kanagawa (JP); Yojiro TONOUCHI, Tokyo (JP); Shinichiro KOTO, Tokyo (JP)

(73) Assignee: KABUSHIKI KAISHA TOSHIBA, Tokyo (JP)

(21) Appl. No.: 14/061,318

(22) Filed: Oct. 23, 2013

Related U.S. Application Data
(63) Continuation of application No. PCT/JP2011/067988, filed on Aug. 5, 2011.

(51) Int. Cl. G06F 3/0488; G06F 3/0481

(52) U.S. Cl. CPC G06F 3/0488; G06F 3/04815
USPC 715/782

(57) ABSTRACT

According to an embodiment, an image processing device includes an obtaining unit, a specifying unit, a first setting unit, a second setting unit, and a processor. The obtaining unit is configured to obtain a three-dimensional image. The specifying unit is configured to, according to an inputting operation performed by a user, specify three-dimensional coordinate values in the three-dimensional image. The first setting unit is configured to set a designated area which indicates an area including the three-dimensional coordinate values. The second setting unit is configured to set a masking area indicating an area that masks the designated area when the three-dimensional image is displayed. The processor is configured to perform image processing with respect to the three-dimensional image in such a way that the masking area is displayed in a more transparent manner as compared to the display of the remaining area.

### CROSS-REFERENCE TO RELATED APPLICATIONS

This application is a continuation of PCT international application Ser. No. PCT/JP2011/067988 filed on Aug. 5, 2011 which designates the United States; the entire contents of which are incorporated herein by reference.

### FIELD

Embodiments described herein relate generally to an image processing device, an image display apparatus, an Image processing method, and a computer program medium.

### BACKGROUND

Typically, medical diagnostic imaging devices such as X-ray CT (Computed Tomography) scanners, MRI (Magnetic Resonance Imaging) devices, or ultrasound diagnostic devices; devices that are capable of generating three-dimensional medical images (volume data) have been put to practical use. In such devices, it becomes possible to select, of the volume data that is generated, a cross-sectional image that contains a body part (for example, an organ) which the user wishes to observe, and a volume rendering operation can be performed with respect to the selected image. Then, a stereoscopic display can be performed with the use of a plurality of parallax images that are obtained as a result of the volume rendering operation.

However, in the technique mentioned above, the user is not able to understand the entire scope of the volume data as well as understand the internal structure of a portion at the same time.

### BRIEF DESCRIPTION OF THE DRAWINGS

FIG. 1 is a block diagram of an image display apparatus;

FIG. 2 is a block diagram of an image processing device;

FIG. 3 is a diagram for explaining volume data;

FIG. 4 is a front view of a monitor;

FIG. 5 is a side view of the monitor;

FIG. 6 is a conceptual diagram for explaining a designated areas and a masking area;

FIG. 7 is a flowchart for explaining an example of operations performed by the image display apparatus;

FIG. 8 is a diagram illustrating a display example;

FIG. 9 is a modification example of the masking area;

FIG. 10 is a modification example of the masking area; and

FIG. 11 is a modification example of the masking area.

### DETAILED DESCRIPTION

According to an embodiment, an image processing device includes an obtaining unit, a specifying unit, a first setting unit, a second setting unit, and a processor. The obtaining unit is configured to obtain a three-dimensional image. The specifying unit is configured to, according to an inputting operation performed by a user, specify three-dimensional coordinate values in the three-dimensional image. The first setting unit is configured to set a designated area which indicates an area including the three-dimensional coordinate values. The second setting unit is configured to set a masking area indicating an area that masks the designated area when the three-dimensional image is displayed. The processor is configured to perform image processing with respect to the three-dimensional image in such a way that the masking area is displayed in a more transparent manner as compared to the display of the remaining area.

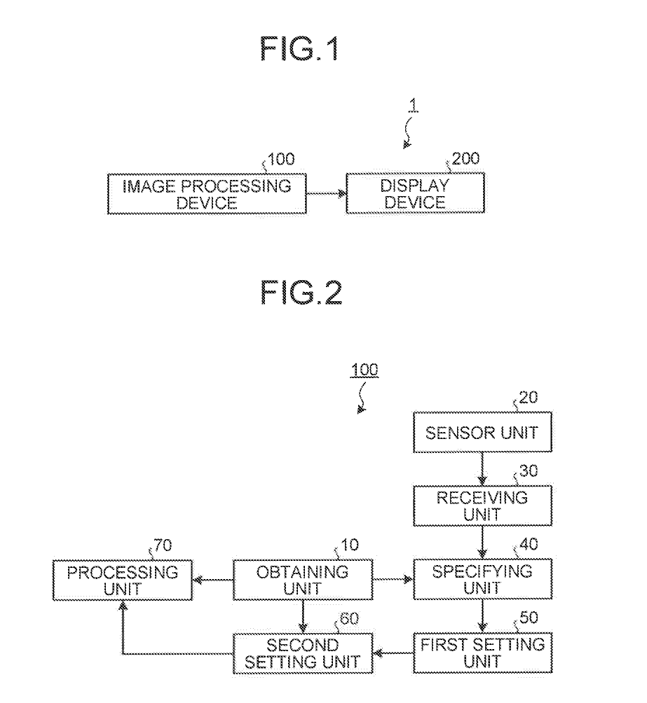

An embodiment of an image processing device, an image display apparatus, an image processing method, and a program according to the present invention is described below in detail with reference to the accompanying drawings. FIG. 1 is a block diagram of an exemplary overall configuration of an image display apparatus 1 according to the embodiment. The image display apparatus 1 includes an image processing device 100 and a display device 200. In the embodiment, the image processing device 100 performs image processing with respect to three-dimensional images that are obtained. The details regarding the image processing are given later. The display device 200 performs a stereoscopic display of three-dimensional images by referring to the result of image processing performed by the image processing device 100.

In the embodiment, while viewing an image that is displayed in a stereoscopic manner on a monitor (not illustrated), the user specifies (points) a predetermined position in the three-dimensional space on the monitor using, for example, a pen. As a result, an area is estimated that is believed to be the area which the user wishes to observe, and that estimated area is displayed in an exposed manner from the entire image. Explained below are the details regarding the same.

FIG. 2 is a block diagram illustrating a configuration example of the image processing device 100. Herein, the image processing device 100 includes an obtaining unit 10, a sensor unit 20, a receiving unit 30, a specifying unit 40, a first setting unit 50, a second setting unit 60, and a processing unit 70.

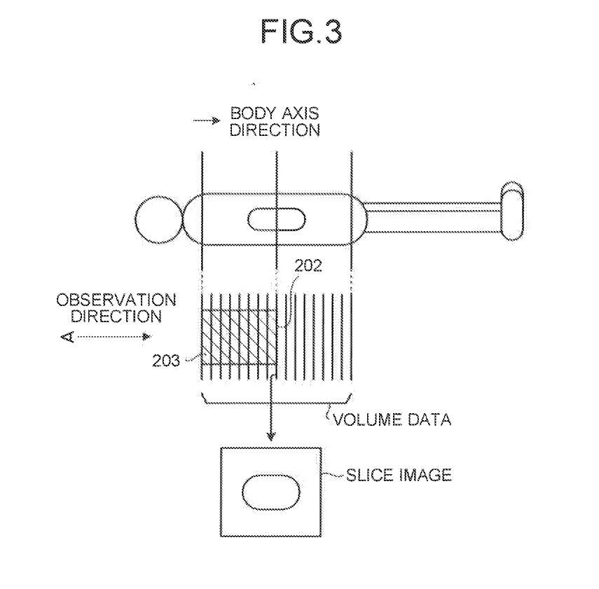

The obtaining unit 10 obtains three-dimensional images. Herein, any arbitrary method can be implemented to obtain three-dimensional images. For example, the obtaining unit 10 either can obtain three-dimensional images from a database or can access a server device to obtain three-dimensional images that are stored in the server device. Meanwhile, in the embodiment, the three-dimensional images obtained by the obtaining unit 10 represents medical volume data. Herein, as illustrated in FIG. 3, a plurality of slice images (cross-sectional images) are captured along the body axis direction or a subject to be tested using an X-ray CT scanner, and the set of captured slice images is used as medical volume data. However, that is not the only possible case, and the obtaining unit 10 can obtain any type of three-dimensional images. For example, the obtaining unit 10 can obtain three-dimensional images created with the use of three-dimensional computer graphics (3DCG). Moreover, apart from three-dimensional images, the obtaining unit 10 can also obtain image information required for the purpose of rendering. Generally, the image information is appended to three-dimensional images. Consider the case when the three-dimensional images are created with the use of 3DCG. In that case, as image information, it is possible either to obtain apex point information or material information of objects that have been subjected to modeling in a virtual three-dimensional space or to obtain light source information of a light source to be disposed in a hypothetical three-dimensional space. Moreover, if the three-dimensional images represent medical volume data containing the set or slice images that are captured using an X-ray CT scanner; then, as image information, it is possible to obtain information that contains IDs for identifying the slice images and contains the X-ray dosage of each voxel, and to obtain information of areas divided according to body parts such as veins, arteries, heart, bones, tumors captured in each slice image.

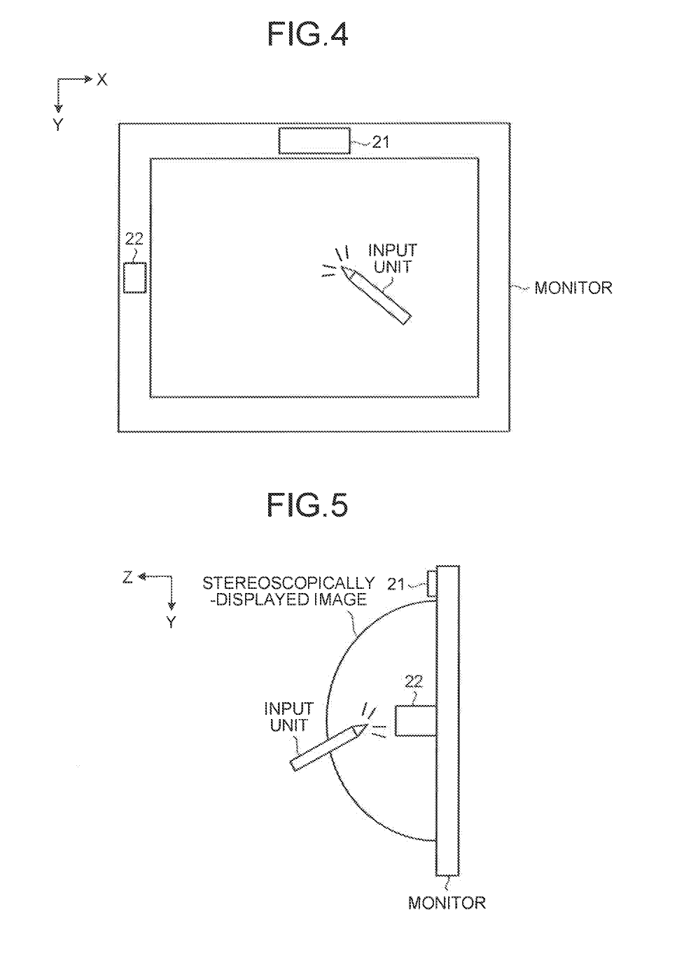

The sensor unit 20 defects (calculates) the coordinate values of an input unit (such as a pen) in the three-dimensional space on a monitor on which a stereoscopic image (described later) is displayed. FIG. 4 is front view of the monitor, and FIG. 5 is a side view of the monitor. As illustrated in FIG. 4 and FIG. 5, the sensor unit 20 includes a first detecting unit 21 and a second detecting unit 22. Meanwhile, in the embodiment, the input unit that is used for user input is configured with a pen that emits sound waves or infrared light from the tip thereof. The first detecting unit 21 detects the position of the input unit in the X-Y plane illustrated in FIG. 4. More particularly, the first detecting unit 21 detects the sound waves and the infrared light emitted from the input unit; and, based on the time taken by the sound waves to reach the first detecting unit 21 and the time taken by the infrared light to reach the first detecting unit 21, calculates the coordinate value in the X direction of the input unit and the coordinate value in the Y direction of the input unit. Moreover, the second detecting unit 22 detects the position of the input unit in the Z direction illustrated in FIG. 5. In an identical manner to the first detecting unit 21, the second detecting unit 22 detects the sound waves and the infrared light emitted from the input unit; and, based on the time taken by the sound waves to reach the second detecting unit 22 and the time taken by the infrared light to reach the second detecting unit 22, calculates the coordinate values in the Z direction of the input unit. Meanwhile, the input unit is not limited to the explanation given above, and can be configured with a pen that either emits only sound waves or emits only infrared light. In that, case, the first detecting unit 21 detects the sound waves (or the infrared light) emitted from the input unit; and, based on the time taken by the sound waves (or by she infrared light) to reach the first detecting unit 21, can calculate the coordinate value in the X direction of the input unit and the coordinate value in the Y direction of the input unit. In an identical manner, the second detecting unit 22 detects the sound waves (or the infrared light) emitted from the input unit; and, based on the time taken by the sound waves (or by the infrared light) to reach the second detecting unit 22, can calculate the coordinate values in the Z direction of the input unit.

Herein, the configuration of the sensor unit 20 is not limited to the explanation given above. In essence, as long as the sensor unit 20 can calculate the coordinate values of the input unit in the three-dimensional space on the monitor, any configuration can be implemented. Moreover, the type of the input unit is also not limited to a pen. For example, a finger of the user can also serve as the input unit, or a surgical knife or medical scissors can also serve as the input unit. In the embodiment, in the case when the user views an image that is displayed in a stereoscopic manner on the monitor and specifies a predetermined position in the three-dimensional space on the monitor using an input unit, the sensor unit 20 detects the three-dimensional coordinate values (x, y, z) at that point of time of the input unit.

The receiving unit 30 receives input of the three-dimensional coordinate values (x, y, z) detected by the sensor unit 20 (that is, receives she user input). The user input means an inputting operation performed by the user. The specifying unit 40 specifies, according to the user input, the three-dimensional coordinate values within a three-dimensional image obtained by the obtaining unit 10. In the embodiment, the specifying unit 40 converts the three-dimensional coordinate values (x, y, z), which are received by the receiving unit 30, into the coordinate system within the volume data that is obtained by the obtaining unit 10; and specifies post-conversion three-dimensional coordinate values (x2, y2, z2).

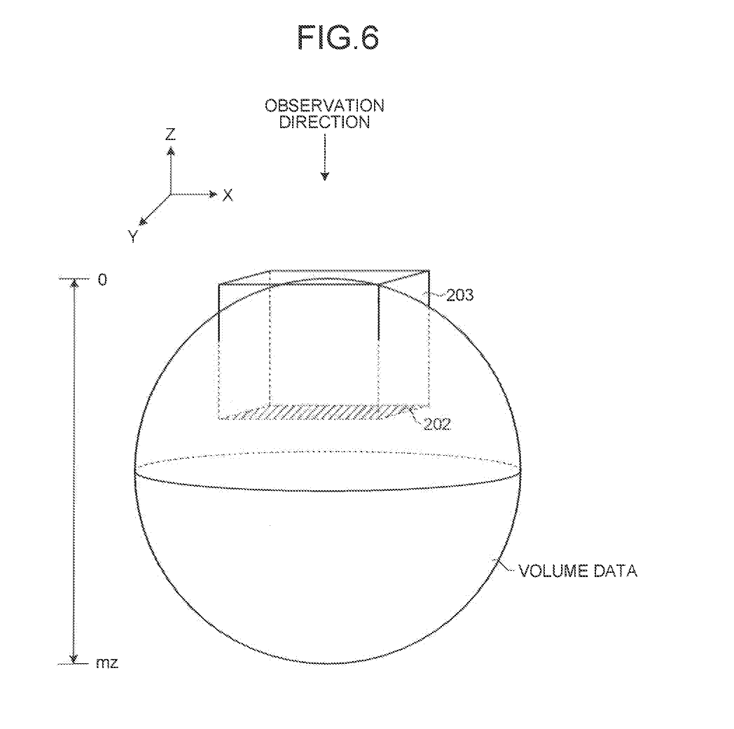

The first setting unit 50 sets a designated area that indicates an area containing the three-dimensional coordinate values specified by the specifying unit 40. As an example, if (x2, y2, z2) are the three-dimensional coordinate values specified by the specifying unit 40; then the first setting unit 50 can set, as a designated area, a rectangular area having four apex points (x2−α, y2+α, z2+α), (x2+α, y2+α, z2+α), (x2+α, y2−α, z2+α),and(x2−α, y2−α, z2+α)around the three-dimensional coordinate values (x2, y2, z2) that have been specified. FIG. 6 is a conceptual diagram of volume data. In this example, a rectangular area 202 illustrated in FIG. 6 is set as the designated area. Meanwhile, the method of setting the designated area is not limited to the explanation given above, and any arbitrary method can be implemented.

The second setting unit 60 sets a masking area that masks the designated area when the three-dimensional image is displayed. As an example, if the rectangular area 202 illustrated in FIG. 6 is set as the designated area; then the second setting unit can set, as a masking area, a quadrangular prism area 203 having the area 202 as the bottom surface thereof. Consider that the coordinate value in the Z direction is in the range from zero to mz. Then, the closer the coordinate value to zero, the closer is the position to the user side; and the closer the coordinate value to mz (i.e., the farther the coordinate value from zero), the more distant is the position from the user side. If the example illustrated in FIG. 6 is replaced by the example illustrated in FIG. 3, then the area illustrated using hatched lines in FIG. 3 corresponds to the masking area 203. Meanwhile, the method of setting the masking area is not limited to the explanation given above, and any arbitrary method can be implemented.

The processing unit 70 performs image processing with respect to a three-dimensional image (volume data), which is obtained by the obtaining unit 10, in such a way that the masking area set by the second setting unit 60 is displayed in a more transparent manner as compared to the display of the remaining area (i.e., the area other than the masking area). As an example, the processing unit 70 sets a rate of permeability of each pixel in the volume data, which is obtained by the obtaining unit 10, to ensure that the masking area set by the second setting unit 60 is displayed in a more transparent manner as compared to the display of the remaining area. In this example, the closer the rate of permeability of a pixel to “1”, the more that pixel is displayed in a transparent manner; and the closer the rate of permeability of a pixel to “0”, the more that pixel is displayed in a non-transparent manner. Hence, the processing unit 70 sets “1” as the rate of permeability of each pixel in the masking area set by the second setting unit 60; and sets “0” as the rate of permeability of each pixel in the remaining area. Meanwhile, the rate of permeability of each pixel in the masking area need not be necessarily set to “1”. That is, as long as the rate of permeability in the masking area is set to a value within a range that enables the display in a more transparent manner as compared to the area other than the masking area, the purpose is served.

Moreover, in the embodiment, with respect to the volume data to which the abovementioned image processing has been performed, the processing unit 70 performs a volume rendering operation in which the viewpoint position (observation position) is shifted by a predetermined parallactic angle every time; and generates a plurality of parallax images. Then, the plurality of parallax images are sent to the display device 200. Subsequently, the display device 200 performs a stereoscopic display using the plurality of parallax images received from the processing unit 70. In the embodiment, the display device 200 includes a stereoscopic display monitor that allows the observer (user) to do stereoscopic viewing of a plurality of parallax images. Herein, it is possible to use any type of stereoscopic display monitor. For example, by using a light beam control element such as a lenticular lens, it becomes possible to have a stereoscopic display monitor that emits a plurality of parallax images in multiple directions. In such a stereoscopic display monitor, the light of each pixel in each parallax image is emitted in multiple directions so that the light entering the right eye and the light entering the left eye of the observer changes in tandem with the position of the observer (i.e., in tandem with the position of the viewpoint). Then, at each viewpoint, the observer becomes able to stereoscopically view the parallax images with the unaided eye. As another example of a stereoscopic display monitor, if a special instrument such as special three-dimensional glasses is used, it becomes possible to have a stereoscopic display monitor that enables stereoscopic viewing of double parallax images (binocular parallax images).

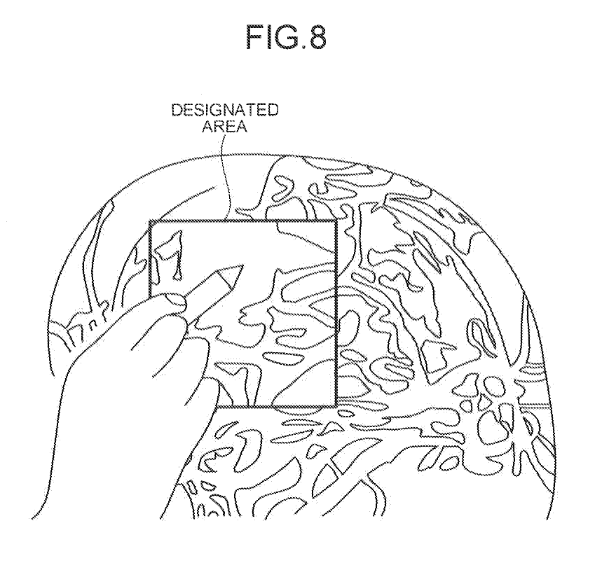

As described, above, the processing unit 70 sets the rate of permeability of each pixel in the volume data in such a way that the masking area set by the second setting unit 60 is displayed in a more transparent manner as compared to the display of the remaining area. Therefore, in an image that is displayed in a stereoscopic manner by the display device 200, the designated area is displayed in an exposed manner (in other words, the masking area is not displayed). FIG. 8 is a diagram illustrating a display example when a blood vessel image within a masking area is hollowed out so that the designated area is displayed in an exposed manner.

Meanwhile, in the embodiment, although the processing unit 70 performs a volume rendering operation to generate a plurality of parallax images, that is not the only case. Alternatively, for example, the display device 200 can perform a volume rendering operation to generate a plurality of parallax images. In that case, the processing unit 70 sends, to the display device 200, the volume data that has been subjected to the abovementioned image processing. Then, with respect to the processing data received from the processing unit 70, the display device 200 performs a volume rendering operation to generate a plurality of parallax images and then displays the parallax images in a stereoscopic manner. In essence, as long as the display device 200 makes use of the result of image processing performed by the processing unit 70 and displays three-dimensional images in a stereoscopic manner, it serves the purpose.

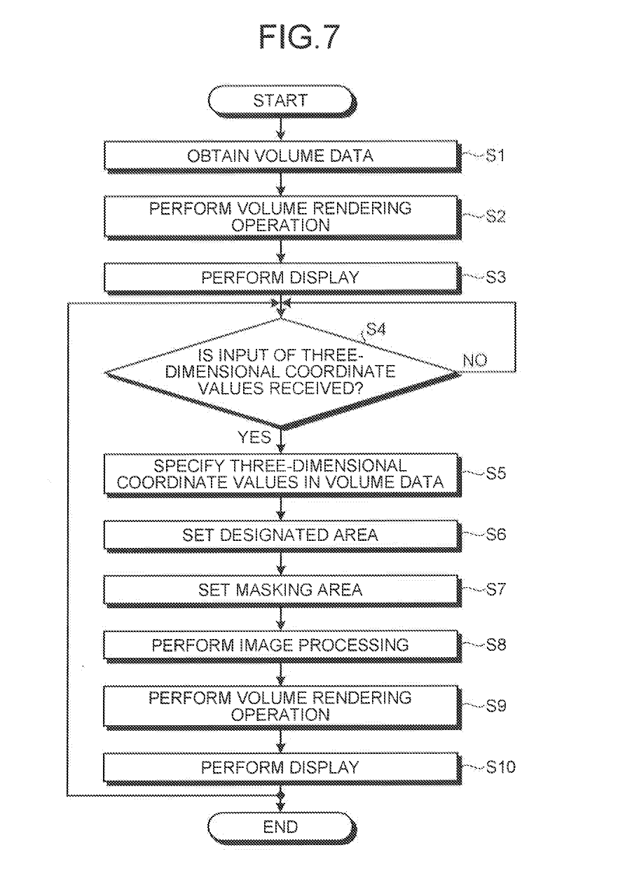

Explained below is an example of operations performed by the image display apparatus 1 according to the embodiment. FIG. 7 is a flowchart for explaining an example of operations performed by the image display apparatus 1 according to the embodiment. As illustrated in FIG. 7, firstly, the obtaining unit 10 obtains volume data (Step S1). Then, with respect to the volume data obtained at Step S1, the processing unit 70 performs a volume rendering operation (Step S2) and generates a plurality of parallax images. The processing unit 70 then sends the plurality of parallax images to the display device 200. Subsequently, the display device 200 emits the parallax image, which is received from the processing unit 70, in multiple directions; and displays the parallax images in a stereoscopic manner (Step S3).

When the receiving unit 30 receives input of three-dimensional coordinates (YES at Step S4); the specifying unit 40 specifies, depending on the three-dimensional coordinate values that are received, three-dimensional coordinates within the volume data that is obtained by the obtaining unit 10 (Step S5). As described above, in the embodiment, the specifying unit 40 converts the three-dimensional coordinate values, which are received by the receiving unit 30, into the coordinate system within the volume data; and specifies post-conversion three-dimensional coordinate values. Then, the first setting unit 50 sets a designated area that indicates an area containing the three-dimensional coordinate values specified at Step S5 (Step S6). The second setting unit 60 sets a masking area indicating an area which, when the three-dimensional image is displayed, masks the designated area set at Step S5 (Step S7). Then, the processing unit 70 performs image processing with respect to the volume data in such a way that the masking area set at Step S7 is displayed in a more transparent manner as compared to the display of the remaining area (Step S8). Subsequently, with respect to the volume data that has been subjected to image processing at Step S8, the processing unit 70 performs a volume rendering operation to generate a plurality of parallax images (Step S9). Then, the processing unit 70 sends the plurality of parallax images to the display device 200; and then the display device 200 emits the plurality of parallax images, which are received from the processing unit 70, in multiple directions and displays the parallax images in a stereoscopic manner (Step S10). The system control then returns to Step S4, and the Operations from Step S4 to Step S10 are repeated.

As described above, in the embodiment, the processing unit 70 performs image processing with respect to the volume data in such a way that the masking area that masks the display area is displayed in a more transparent manner as compared to the display of the remaining area. At the time when a plurality of parallax images that are obtained by performing a volume rendering operation with respect to the post-image-processing volume data are displayed in a stereoscopic manner, the designated area gets displayed in an exposed manner. Thus, according to the embodiment, the entire scope of the volume data as well as the internal structure of a portion (i.e., the designated area) can be displayed at the same time. Moreover, in the embodiment, while viewing an image displayed in a stereoscopic manner, the user can specify a predetermined position in the three-dimensional space on the monitor using the input unit. As a result, the area (designated area) that the user wishes to observe can be exposed. Thus, the user can perform the operation of specifying a desired area in an instinctive and efficient manner.

Although the present invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth. Given below is the explanation of modification examples. Herein, it is possible to arbitrarily combine two or more of the modifications explained below.

### (1) First Modification Example

In order to set the designated area, the first setting unit 50 can implement any arbitrary method. For example, as the designated area, it is possible to set an area within a circle that has a radius “r” and that drawn on the X-Y plane around the three-dimensional coordinate values (x2, y2, z2) specified by the specifying unit 40. Moreover, for example, the three-dimensional coordinate values (x2, y2, z2) specified by the specifying unit 40 can be considered to be one of one apex points of a rectangle. Furthermore, as the designated area, it is also possible to set an area on a plane other than the X-Y plane (for example, on the X-Z plane or on the Y-Z plane). For example, as the designated area, it is possible to set the area of a rectangle having four apex points (x2−α, y2+α, z2+α), (x2+α, y2+α, z2+α), (x2+α, y2−α, z2−β), and (x2−α, y2−α, z2−β).

Moreover, each of a plurality of slice images that constitutes the volume data can be divided into a plurality of areas for each displayed object. Then, as the designated area, it is possible to set the area to which belongs the object that includes the three-dimensional coordinate values specified by the specifying unit 40 (referred to as “specific object”). In that case, as the designated area, either it is possible to set such an area in a single slice image to which belongs the specific object, or it is possible to set the collection of such areas in all slice images to each of which belongs the specific object.

### (2) Second Modification Example

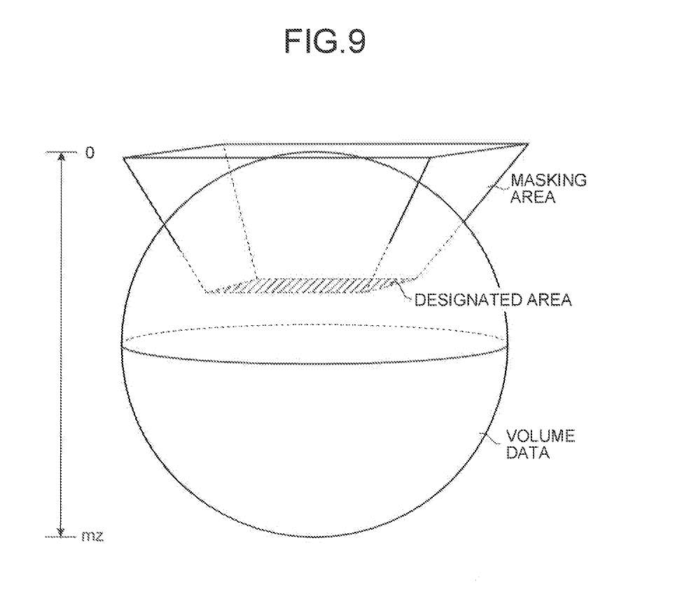

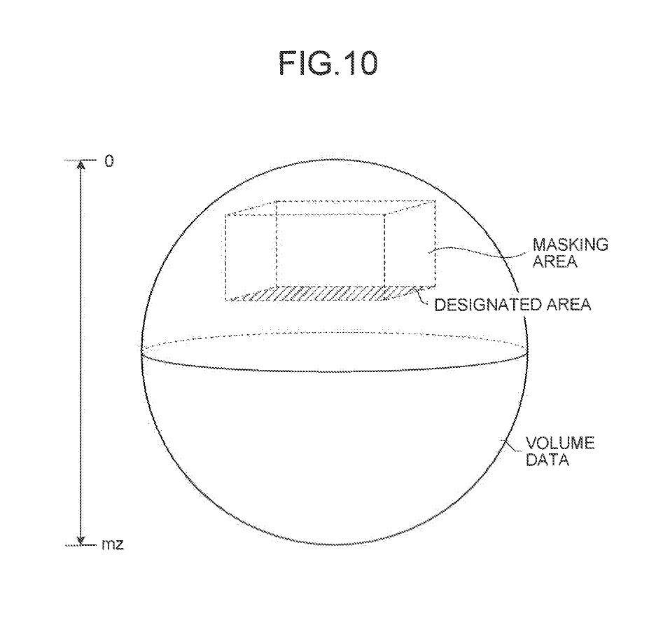

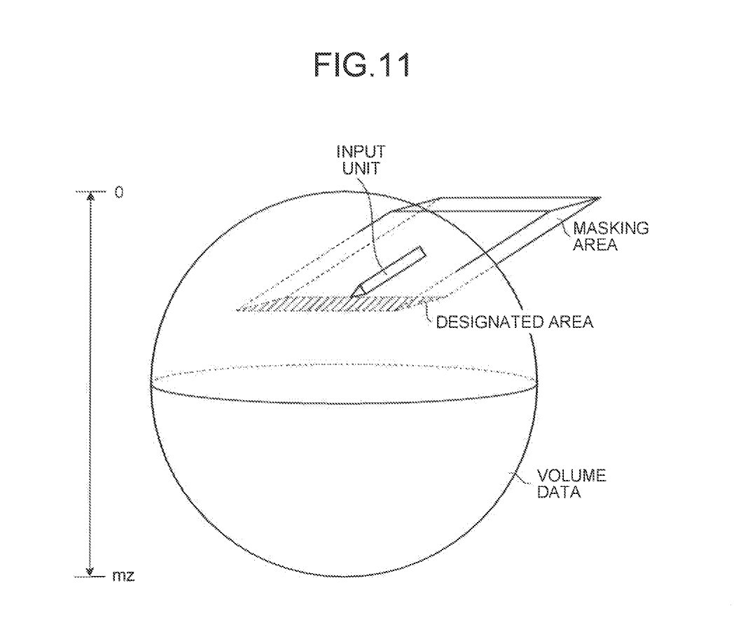

In order to set the masking area, the second setting unit 60 can implement any arbitrary method. For example, an area having the shape as illustrated in FIG. 9 or FIG. 10 can be set as the masking area. Moreover, for example, the masking area can be set to be variable in nature according to the angle of the input unit. More particularly, for example, as illustrated in FIG. 11, the masking area can be set to be an area along the extending direction of the input pen (herein, a pen that emits sound waves).

### (3) Third Modification Example

For example, the processing unit 70 can set the pixel value of each pixel in the masking area, which is set by the second setting unit 60, to a value that makes the corresponding pixel non-displayable. With such a configuration too, since the masking area in the volume data is not displayed, the designated area can be displayed in an exposed manner. In essence, as long as the processing unit 70 performs image processing with respect to the volume data in such a way that the masking area set by the second setting unit 60 is displayed in a more transparent manner as compared to the display of the remaining area, the purpose is served.

### (4) Fourth Modification Example

For example, the processing unit 70 can perform image processing with respect to the volume data in such a way that, of the objects displayed in each slice image, the portion included in the masking area is displayed in a more transparent manner as compared to the display of the remaining area. In an identical manner to the embodiment described above, the processing unit 70 can set the rate of permeability of each pixel in the volume data in such a way that, of the objects displayed in each slice image, the portion included in the masking area is displayed in a more transparent manner as compared to the display of the remaining area. Alternatively, of the objects displayed in each slice image, the processing unit 70 can set the pixel value of each pixel in the portion included in the masking area to a value that makes the corresponding pixel non-displayable. Still alternatively, the processing unit 70 can perform image processing in such a way that, of the objects displayed in each slice image, the other-than-contoured-part of the portion included in the masking area is displayed in a more transparent manner as compared to the display of the remaining area.

Moreover, if objects of a plurality of types are displayed in each slice image; then, the processing unit 70 can perform image processing in such a way that, regarding ail objects, the portion included in the masking area is displayed in a more transparent manner. Similarly, the processing unit 70 can perform image processing in such a way that, regarding user-specified objects, the portion included in the masking area is displayed in a more transparent manner. For example, if the user specifies objects of blood vessels from among various objects (such as objects of bones, organs, blood vessels, or tumors) displayed in each slice image that constitutes medical volume data; then the processing unit 70 can perform image processing in such a way that, of the objects of blood vessels, the portion included in the masking area is displayed in a more transparent manner as compared to the display of the remaining area. In an identical manner to the embodiment described above, the processing unit 70 can set the rate of permeability of each pixel in the volume data in such a way that, of the objects of blood vessels, the portion included in the masking area is displayed in a more transparent manner as compared to the display of the remaining area. Alternatively, of the objects of blood vessels, the processing unit 70 can set the pixel value of each pixel in the portion included in the masking area to a value that makes the corresponding pixel non-displayable. Still alternatively, the processing unit 70 can perform image processing in such a way that, of the objects of blood vessels, the other-than-contoured-part of the portion included in the masking area is displayed in a more transparent manner as compared to the display of the remaining area. Meanwhile, the user can specify objects of any number of types as well as can specify any number of objects.

### (5) Fifth Modification Example

In the embodiment described above, the user operates an input unit such as a pen to input three-dimensional values in the three-dimensional space on a monitor. However, that is not the only possible case. That is, any arbitrary method of inputting the three-dimensional values can be implemented. For example, the user can operate a keyboard to directly input three-dimensional values in the three-dimensional space on the monitor. Alternatively, the configuration can be such that the user operates a mouse to specify two-dimensional coordinate values (x, y) on the screen of the monitor, and the coordinate value in the Z direction gets input depending on the value of the mouse wheel or depending on the time for which clicking is continued. Still alternatively, the configuration can be such than the user performs a touch operation to specify two-dimensional coordinate values (x, y) on the screen of the monitor screen, and the coordinate value in the Z direction gets input depending on the time for which the screen is touched. Still alternatively, the configuration can be such that, when the user touches the monitor screen, there appears a slide bar on which the sliding amount changes in response to the user operation; and the coordinate value in the Z direction gets input depending on the sliding amount.

The image processing device according to the embodiment described above as well as according to each modification example has a hardware configuration including a CPU (Central Processing Unit), a ROM, a RAM, and a communication I/F. The CPU loads a program, which is stored in the ROM, in the RAM and executes it. As a result, the functions of each of the abovementioned constituent elements are implemented. However, the configuration is not limited to the abovementioned configuration, and at least some of the constituent elements can be implemented using independent circuits (hardware).

Meanwhile, the program executed in the image processing device according to the embodiment described above as well as according to each modification example can be saved in a downloadable manner on a computer connected to a network such as the Internet. Alternatively, the program executed in the image processing device according to the embodiment described above as well as according to each modification example can be distributed over a network such as the Internet. Still alternatively, the program executed in the image processing device according to the embodiment described above as well as according to each modification example can be stored in advance in a ROM or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of cue inventions. The accompanying claims and their equivalents are intended to cover such forms or modifications as would fall within the scope and spirit of the inventions.

What is claimed is:

1. An image processing device comprising:
an obtaining unit configured to obtain a three-dimensional image;
a specifying unit configured to, according to an inputting operation performed by a user, specify three-dimensional coordinate values in the three-dimensional image;
a first setting unit configured to set a designated area which indicates an area including the three-dimensional coordinate values;
a second setting unit configured to set a masking area indicating an area that masks the designated area when the three-dimensional image is displayed; and
a processor configured to perform, image processing with respect to the three-dimensional image in such a way that the masking area is displayed in a more transparent manner as compared to the display of the remaining area.

2. The device according to claim 1, wherein the processor sets a rate of permeability of each pixel in the three-dimensional image in such a way that the masking area is displayed in a more transparent manner as compared to the display of the remaining area.

3. The device according to claim 1, wherein the processor sets the pixel value of each pixel in the masking area to a value that makes corresponding pixel non-displayable.

4. The device according to claim 1, wherein
the three-dimensional image represents volume data that is made of a plurality of cross-sectional images formed along a predetermined axis direction of a target object, and each of the plurality of cross-sectional images is divided into a plurality of areas for each displayed object, and
the first setting unit sets, as the designated area, an area to which the object belongs, the area including the three-dimensional coordinate values specified by the specifying unit.

5. The device according to claim 1, wherein
the three-dimensional image represents volume data that is made of a plurality of cross-sectional images formed along a predetermined axis direction of a target object, and
the processor performs image processing in such a way that, of objects displayed in each of the cross-sectional images, a portion included in the masking area is displayed in a more transparent manner as compared to the display of the remaining area.

6. The device according to claim 5, wherein the processor performs image processing in such a way that, of the objects, an other-than-contoured-part of the portion included in the masking area is displayed in a more transparent manner as compared to the display of the remaining area.

7. The device according to claim 1, wherein the second setting unit sets she masking area to be variable according to an angle of an input unit that is used by the user for performing the inputting operation.

8. The device according to claim 1, further comprising a sensor configured to detect three-dimensional coordinate values of an input unit that is used by the user for performing the inputting operation, wherein
the specifying unit specifies the three-dimensional coordinate values in the three-dimensional image by referring to the three-dimensional, coordinate values detected by the sensor.

9. The device according to claim 8, wherein the sensor detects the three-dimensional coordinate values of the input unit in a three-dimensional space on a monitor on which a stereoscopic image is displayed.

10. An image display apparatus comprising:
an obtaining unit configured to obtain a three-dimensional image;
a specifying unit configured to, according to an inputting operation performed by a user, specify three-dimensional coordinate values in the three-dimensional image;
a first setting unit configured to set a designated area which indicates an area including the three-dimensional coordinate values;
a second setting unit configured to set a masking area indicating an area that masks the designated area when the three-dimensional image is displayed;
a processor configured to perform image processing with respect to the three-dimensional image in such a way that the masking area is displayed in a more transparent manner as compared to the display of the remaining area; and
a display device configured to display the three-dimensional image in a stereoscopic manner according to the result of the image processing.

11. An image processing method comprising:
obtaining a three-dimensional image;
specifying, according to an inputting operation performed by a user, three-dimensional coordinate values in the three-dimensional image;
setting a designated area which indicates an area including the three-dimensional coordinate values;
setting a masking area indicating an area that masks the designated area when the three-dimensional image is displayed; and
performing image processing with respect to the three-dimensional image in such a way that the masking area is displayed in a more transparent manner as compared to the display of the remaining area.

12. A computer program medium comprising a computer-readable medium containing programmed instructions that cause a computer to execute:
obtaining a three-dimensional image;
specifying, according to an inputting operation performed by a user, three-dimensional coordinate values in the three-dimensional image;
setting a designated area which indicates an area including the three-dimensional coordinate values;
setting a masking area indicating an area that masks the designated area when the three-dimensional image is displaced; and
performing image processing with respect to the three-dimensional image in such a way that the masking area is displayed in a more transparent manner as compared to the display of the remaining area.
